(19) United States
(12) Patent Application Publication
(10) Pub. No.: US 2003/0216929 A1
(43) Pub. Date: Nov. 20, 2003

(54) Method, system and program product for presenting web content according to a determined learning style

(75) Inventors: Brandon Brockway, Austin, TX (US); Christopher T. Howle, Austin, TX (US); Michael A. Paolini, Austin, TX (US); Scott Lee Winters, Austin, TX (US)

Correspondence Address: HOFFMAN WARNICK & D'ALESSANDRO, LLC, 3 E-COMM SQUARE, ALBANY, NY, 12207

(73) Assignee: INTERNATIONAL BUSINESS MACHINES CORPORATION, Armonk, NY

(21) Appl. No.: 10/150,006

(22) Filed: May 16, 2002

(51) Int. Cl. G06F 17/60

(52) U.S. Cl. 705/1

(57) ABSTRACT

A method, system and program product for presenting web content according to a determined learning style is provided. Specifically, an updatable presentation profile will be developed for a user based on previous and current navigational choices made by the user. Once developed, the profile can be manipulated based on an algorithm to determine the user's learning style. Then, any web content corresponding to a current navigational choice made by the user will be presented in a format that best pertains to the user's learning style.

### BACKGROUND OF THE INVENTION

1. Field of the Invention

A method, system and program product for presenting web content according to a determined learning style is provided. Specifically, the present invention determines a learning style of a user based on website navigational choices, and presents web content according to the determined learning style.

2. Background Art

As the use of the world wide web becomes more pervasive, web users are increasingly seeking to obtain everyday information from websites. Accordingly, business have begun to develop websites that are both informative and user friendly. In many instances, a well developed website can be the difference between success and failure in the marketplace.

Heretofore, businesses have attempted to capitalize on increased world wide web use by tracking the type of content users access, and then directing specific content to each user. Although this allows the content to be tailored to the users, the manner in which the content is presented remains static. Specifically, while the content itself may change, the style and/or framework in which it is presented does not change to best meet the communication needs of the user. Changing the presentation style could be advantageous because not all users communicate and learn in the same manner. For example, some users are reached more effectively by visual means, while others are reached more effectively by auditory means. Likewise, some users may understand and retain content better and/or faster when it is presented visually in forms such as diagrams, images and graphics, while other users may respond better to content presented visually in the form of textual descriptions, numbers, table, and the like. Thus, the “one learning style fits all” static manner in which website content is currently presented is not the most effective way to convey the information to the intended, individualized recipient. As such, revenue opportunities may suffer.

In view of the foregoing, there exists a need for a method, system and program product for presenting web content according to a determined learning style. A further need exists for a presentation profile to be developed based on website navigational choices made by a web user. Still yet, a need exists for a learning style to be determined based on a user's presentation profile. Moreover, a need exists for web content to be presented according to a user's determined learning style.

### SUMMARY OF THE INVENTION

The present invention generally relates to a method, system and program product for presenting web content according to a determined learning style. Specifically, under the present invention, a user makes a navigational choice on a website. Based on the navigational choice, a presentation profile is developed (established or updated). In a typical embodiment, the presentation profile comprises at least one presentation value that is assigned based on the user's current and previous navigational choices. Then, by manipulating the presentation values according to a definable algorithm, a learning style for the user can be determined. Web content will then be presented to the user according to the determined learning style.

According to a first aspect of the present invention, a method for presenting web content according to a determined learning style is provided. The method comprises: (1) developing a presentation profile based on a website navigational choice; (2) determining a learning style based on the presentation profile; and (3) presenting web content according to the learning style.

According to a second aspect of the present invention, a method for presenting web content according to a determined learning style is provided. The method comprises: (1) a user making a website navigational choice; (2) developing a presentation profile for the user by assigning at least one presentation value based on the website navigational choice; (3) determining a learning style for the user by manipulating the at least one presentation value according to a definable algorithm; and (4) presenting web content corresponding to the website navigational choice according to the learning style.

According to a third aspect of the present invention, a system for presenting web content according to a determined learning style is provided. The system comprises: (1) a registration system for assigning an identification to a user; (2) a profile system for developing a presentation profile based on a website navigational choice made by the user; (3) a style system for determining a learning style based on the presentation profile; and (4) a rendering system for presenting web content according to the learning style.

According to a fourth aspect of the present invention, a program product stored on a recordable medium for presenting web content according to a determined learning style is provided. When executed, the program product comprises: (1) program code for assigning an identification to a user; (2) program code for developing a presentation profile based on a website navigational choice made by the user; (3) program code for determining a learning style based on the presentation profile; and (4) program code for presenting web content according to the learning style.

Therefore, the present invention provides a method, system and program product for presenting web content according to a determined learning style.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a block diagram according to the present invention.

FIG. 2 depicts exemplary hyperlinks according to the present invention.

FIG. 3 depicts a computer system having a presentation system, according to the present invention.

FIG. 4 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

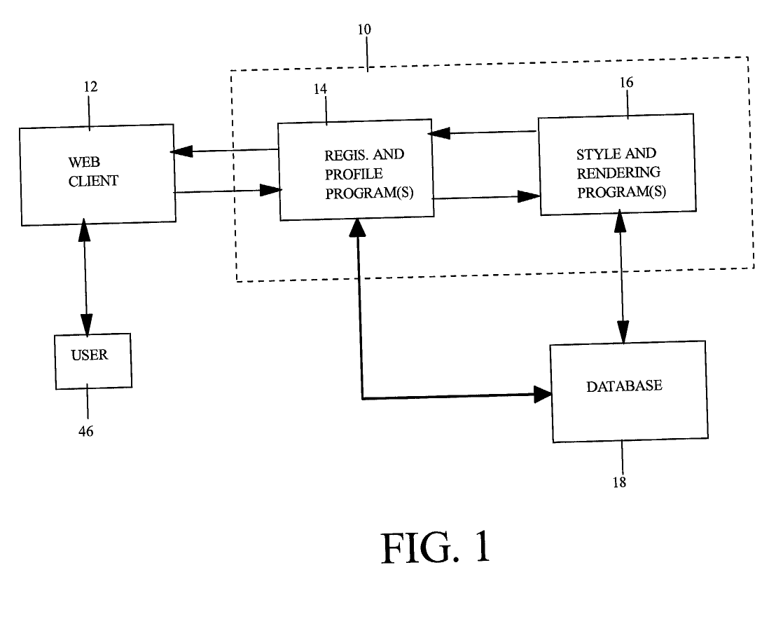

Referring to FIG. 1, a block diagram according to the present invention is shown. In general, the present invention allows web content to be displayed to a user 46 according to user's 46 learning style. For example, if user 46 arrives at a product description web page by selecting an image hyperlink of that product (as opposed to a textual hyperlink), then additional information related to the product will be presented with a graphical emphasis. As depicted, web client 12 (operated by user 46) is used to communicate with web server 10 for navigating about a website. Web server 10 includes one or more programs 14 and 16 (which will be further described below) for presenting web content to user 46 according to user's 46 learning style.

Upon entering a website for the first time, user 46 will be prompted to register. Registration generally includes user 46 providing background information (e.g., name, address, etc.) and being assigned (by his/herself or web server 10) a user identification. Once assigned, the user identification will be stored on web client 12 (typically via a cookie). After registration, user 46 is free to make one or more navigational choices. That is, user 46 will select one or more hyperlinks within the website.

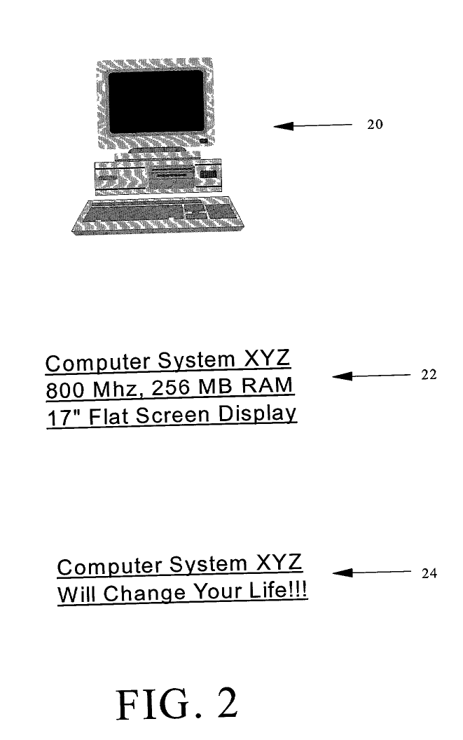

Under the present invention, an initial presentation profile for user 46 will be established (developed) based on several factors that include, for example, the navigational choices made by user 46, the referring website, etc. In general, the presentation profile comprises presentation values (e.g., 1, 2, 3, etc.) that are assigned to user 46 based on these factors. FIG. 2 depicts some exemplary navigational choices that can be made by user 46, and which will be used to develop user's 46 presentation profile. As depicted, user 46 could select graphical hyperlink 20, analytical hyperlink 22 or emotional hyperlink 24. Graphical hyperlink 20 generally appeals to users who have a national tendency for visual learning. Analytical hyperlink 22 generally applies to users who prefer statistical based learning. Similarly, emotional hyperlink 24 generally appeals to users who prefer emotional based learning. It should be understood that other learning styles could be considered under the present invention, and those shown in FIG. 2 are not meant to be exhaustive. For example, an auditory hyperlink could be implemented within a web page for users who prefer auditory based learning. Moreover, combination hyperlinks could be implemented. One example of such a link could be a single hyperlink that includes both graphical hyperlink 20 and analytical hyperlink 22.

In any event, depending on which selection user 46 makes (and other factors such as a referring website), a presentation profile of values will be developed. For example, if the user selected the graphical hyperlink 20, a presentation profile of “visual—3, analytical—0, emotional—0, and auditory—0” could be generated. Conversely, if the user selected a graphical-analytical combination hyperlink a presentation profile of “visual—3, analytical—2, emotional—0, and auditory—0” could be generated. Once developed, the presentation profile will be stored in database 18 (FIG. 1) according to the user identification. Then, based on the presentation profile, a learning style corresponding to user's 46 profile would be determined. In a typical embodiment, the learning style is determined by manipulating the presentation values according to a definable algorithm. The algorithm is definable to allow an operator of web server 10 to determine how to define user's 46 learning style. For example, one algorithm could dictate that the learning style is based on the highest presentation value total. For either exemplary presentation profile discussed above, this would dictate a learning style of “visual.” Alternatively, an algorithm could dictate that a learning style is based on all value totals, with emphasis in presentation going to the highest value totals. For the “visual—3, analytical—2, emotional—0, and auditory—0” profile, a learning style of visual and analytical with an emphasis on visual would result.

Once the learning style has been dictated, web content would be presented to user 46 according to the learning style. For example, if user's 46 learning style was determined to be “visual,” content corresponding to the selected hyperlink (navigational choice) would be presented to user 46 in a graphical format. It should be appreciated that as used herein, the term “content” is intended to include all types of web content. Examples include, among other things, textual language, hyperlinks, etc. For example, if user 46 was determined to have a “visual” learning style, all hyperlinks subsequently presented to user 46 could be graphical hyperlinks.

Once established, the presentation profile and learning style will be dynamically updated based on future interactions (e.g., navigational choices) between user 46 and the website. For example, the next time user 46 visits the website and makes a navigational choice, the user identification will be retrieved from web client 12 and used to access user 46's presentation profile as stored in database 18. Then, the presentation profile will be updated (developed) based on the current navigational choice. Once updated, the learning style will be (re)determined based on the updated presentation profile. The web content will then be displayed in a format that corresponds to the (re)determined learning style.

In updating user's 46 presentation profile, many embodiments are possible. In one embodiment, the presentation profile could be updated to reflect each navigational decision. In another embodiment, updates could be based (in whole or in part) on user's 46 navigational history. For example, a historical analysis of previous choices may be performed to detect anomalies and deviations from user 46's established profile. For example, if user 46 historically has a presentation profile with low (e.g., 1) analytical presentation values, and current navigational choices are resulting in high (e.g., 3) analytical presentation values, an analytical deviation of “2” is present. Such deviations may indicate that a “guest” of user 46 was using his/her account. In one embodiment, user 46's presentation profile is not updated to reflect the learning style of another. Thus, the profile could be left intact. Alternatively, the profile could be slightly updated. For example, a weighted algorithm may be implemented in which the presentation profile would be based mostly on previous navigational decisions (80% for example), while the remaining percentage would be based on the current interaction. In another embodiment, user 46's presentation profile could be updated based on the current interaction but with diminished emphasis. For example, if it was detected that user 46 was generally making unexpected choices, and user 46 clicked on a hyperlink with weight “visual—3,” then instead of updating user 46's presentation profile with 3 visual points, it is updated with only 1 visual point. In yet another embodiment, each deviation is stored and when a predetermined number of deviations are stored, the presentation profile is (e.g., partially or fully) updated. In this case, storage of the deviations also provides the capability to conduct a historical analysis of user 46.

In an alternative embodiment, user 46 could be allowed to designate guest users and (optional) associated guest presentation profiles at registration or any time thereafter. For example, if user's 46 spouse would also be using user's 46 account, user 46 might want to designate the spouse as a registered guest user and provide an appropriate profile for the spouse. Then, the web content could be displayed based on the whichever of the two is currently using the account. To this extent, the individual could be “recognized” based on the current navigational choices. For example, if the spouse had a profile that was heavily analytical, and a guest logged onto user's 46 account and started making analytical navigational choices, the present invention could assume that the guest is the spouse and use the spouse's profile. Alternatively, the spouse could log on as a guest in which case the spouse's profile would be automatically used. In any event, the guest user's presentation profile could be updated based on future navigational choices in the same manner as user's 46 profile.

It should be understood that the term “develop(ed)” as used herein in conjunction with presentation profiles is intended to include both the initial establishment of a personation profile (e.g., for a new user) and/or the updating of an existing presentation profile (for a registered user).

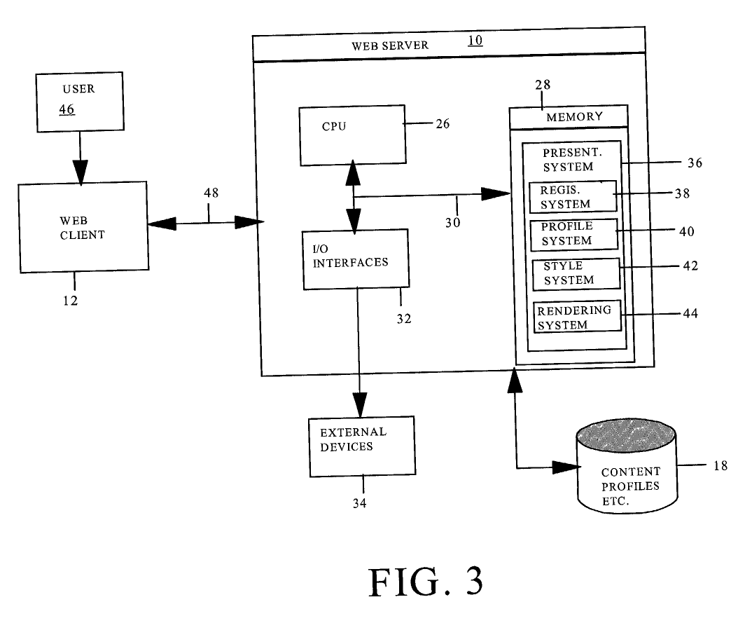

Referring now to FIG. 3, a more detailed implementation of the present invention is shown. As depicted, user 46 operates web client 12 to communicate with web server 10 to access the website hosted thereby. For exemplary purposes, it will be assumed that web server 10 is operated by a single entity (e.g., a business) for providing access to the entity's own website. However, it should be appreciated that many alternatives exist. For example, web server 10 could be operated by an entity for providing access to multiple third parties' websites. In any event, the teachings of the present invention are intended to apply to any scenario.

As shown, web server 10 generally comprises central processing unit (CPU) 26, memory 28, bus 30, input/output (I/O) interfaces 32, external devices/resources 34 and database 18. CPU 26 may comprise a single processing unit, or be distributed across one or more processing units in one or more locations, e.g., on a client and server. Memory 28 may comprise any known type of data storage and/or transmission media, including magnetic media, optical media, random access memory (RAM), read-only memory (ROM), a data cache, a data object, etc. Moreover, memory 28 may reside at a single physical location, comprising one or more types of data storage, or be distributed across a plurality of physical systems in various forms.

I/O interfaces 32 may comprise any system for exchanging information to/from an external source. External devices/resources 34 may comprise any known type of external device, including speakers, a CRT, LED screen, hand-held device, keyboard, mouse, voice recognition system, speech output system, printer, monitor, facsimile, pager, etc. Bus 30 provides a communication link between each of the components in web server 10 and likewise may comprise any known type of transmission link, including electrical, optical, wireless, etc. In addition, although not shown, additional components, such as cache memory, communication systems, system software, etc., may be incorporated into web server 10.

Database 18 may provide storage for information necessary to carry out the present invention such as web content, guest users, presentation profiles, optional guest presentation profiles, etc. As such, database 18 may include one or more storage devices, such as a magnetic disk drive or an optical disk drive. In another embodiment, database 18 includes data distributed across, for example, a local area network (LAN), wide area network (WAN) or a storage area network (SAN) (not shown). Database 18 may also be configured in such a way that one of ordinary skill in the art may interpret it to include one or more storage devices.

Communication between web server 10 and web client 12 occurs via communications link 48. Communications link 48 is intended to represent any possible method of communicating with web server 10. For example web server 10 and web client 12 can communicate via a direct hardwired connection (e.g., serial port), or via an addressable connection (e.g., remotely). In the case of the latter, web server 10 and web client 12 may be connected via the Internet, wide area networks (WAN), local area networks (LAN) or other private networks. Web server 10 and web client 12 may utilize conventional network connectivity, such as Token Ring, Ethernet, or other conventional communications standards. Where web client 12 communicates with web sever 10 via the Internet, connectivity could be provided by conventional TCP/IP sockets-based protocol. In this instance, web client 12 would utilize an Internet service provider to establish connectivity to web server 10.

Stored in memory 28 as a program product is presentation system 36. As depicted, presentation system 36 includes registration system 38, profile system 40, style system 42 and rendering system 44. In a typical embodiment, presentation system 36 comprises one or more servlets implemented under the JAVA programming language. However, it should be understood that the present invention could be implemented using any known programming language. As indicated above, the first time user 46 visits a website hosted by web server 10 (e.g., web server 10 could host more than one website) and makes a navigational choice (i.e., selects a hyperlink), user 46 will be required to register via registration system 38. Registration typically includes assignment of a user identification to user 46, which can be chosen by user 46 or by web server 10. In either event, the assigned user identification will be stored on web client 12 via a cookie or the like. In addition, as indicated above, registration can include designation of one or more guest users and optional guest presentation profiles. In the event that a guest presentation profile is not designated for a guest user, an initial presentation profile will be developed for the guest in the same manner that an initial presentation profile is developed for user 46.

Once registration is complete, profile system 40 will establish (develop) the initial presentation profile of values for user 46. As indicated above, the initial presentation profile is developed based on the navigational choice(s) (e.g., HTTP query stream) made by user 46, as well as any other factors deemed necessary. Such factors could include the referring website. For example, if the referring website was a graphically-based website, user's 46 presentation profile could have graphical values. In any event, the presentation profile will be stored in database 18 and cross-referenced with the user identification. After the presentation profile has been developed, a learning style based on the presentation profile will be determined via style system 42. As indicated above, the learning style is determined by manipulating the presentation values of the profile according to a definable algorithm. Moreover, the algorithm can be any way to manipulate/interpret the presentation values in the profile. An exemplary algorithm could be as follows: “Learning Style=highest presentation value total.” Thus, if the presentation profile for user 46 was “visual—3, auditory—2, analytical—1, emotional—0,” user's 46 learning style would be “visual.”

In a typical embodiment, style system 42 comprises a JAVA-based pluggable rules engine. This allows the algorithm to be easily varied based on the particular website (or owner thereof). For example, if web server 10 is operated to host a single entity's website, style system 42 can be programmed with a single algorithm. Conversely, if web server 10 hosts numerous websites (e.g., owned by numerous entities), style system 42 could contain one algorithm for each website. The applicable algorithm to be implemented could then depend on which website is being accessed by user 46. In any event, algorithm(s) used by style system 42 can be changed at the whim of the website owners and/or web server 10 operator.

It should be appreciated that the particular algorithm used may dynamically change without requiring other software to be restarted (such as the HTTP server or application server). For example, if a user is making a large number of choices that deviate from their established presentation profile, an algorithm more suitable for this situation and/or (guest) user may be swapped in “on the fly.” This is not the only situation that might merit a change in algorithm. Rather, any defined event could cause a new algorithm to be “hot swapped” in; for example, arriving at a particular page, remaining at the site for a particular length of time, or the purchase of a product.

Once the learning style has been determined, the web content requested by user 46 would be presented, via rendering system 44, according to the determined learning style. In one embodiment, database 18 could contain the raw web content that must be formatted into the determined learning style by rendering system 44. For example, if user's 46 learning style was determined to be “visual,” rendering system 44 would format the web content in database 18 to have an emphasis on graphics. Once formatted, rendering system 44 would present the web content to user 46 (e.g., display the web content via a web browser on web client 12). In this embodiment, rendering system 44 typically comprises Extensible Stylesheet Language Transformations (XSLT). XSLT is a standard way to describe how to transform/change the structure of an Extensible Markup Language (XML) document into an XML document with a different structure. To this extent, XSLT can be though of as an extension to Extensible Stylesheet Language (XSL). XSL is a language for formatting an XML document (e.g., showing how the data described in the XML document should be presented in a Web page). XSLT shows how the XML document should be reorganized into another data structure, which could then be presented by following an XSL. In another embodiment, in lieu of raw web content, database 18 could contain the web content already formatted into multiple different learning styles (e.g., multiple different versions). In this case, based on the determined learning style, the most applicable version would be retrieved by rendering system 44 and presented to user 46 (e.g., via user's 46 web browser).

The next time user 46 visits the same website, registration and initial establishment of a presentation profile would not be necessary. Rather, user 46 would enter the website and make a navigational choice. Once a choice is made, profile system 40 would retrieve the user identification from web client 12 (e.g., where it is saved via a cookie) and use it to access user's 46 presentation profile in database 18. Once accessed, the profile will be updated (developed) via profile system 40 as described above. Specifically, the current navigational choice made by user 46 could have affected the presentation values the presentation profile. To this extent, the presentation profile could reflect all current and previous navigational choices (e.g., all HTTP query streams) made by user 46.

Once the profile has been updated, the user identification will be passed to style system 42, which will use it to access the updated presentation profile and (re)determine user's 46 learning style. Since the learning style is based on the presentation profile, any changes to the profile could ultimately affect user's 46 learning style. Similar to previous visits to the website, rendering system 44 would then present the web content corresponding to the current navigational choice according to user's 46 learning style.

As indicated above, the present invention (e.g., profile system 40) could detect whether the individual currently using the system is a “guest” (registered or unregistered) based on deviations from previous navigational choices. This can be important because it might not be desirable to update the user's 46 presentation profile to reflect navigational choices made by guests. In detecting whether the individual using the system is a guest, many variations are possible. In one embodiment, profile system 40 will compare the current navigational choices to user's 46 history (i.e., conduct a historical analysis) to identify deviations. If the current choices substantially deviate from previous choices, the presentation profile could be left intact (i.e., not updated). If this is the case, the web content could be rendered according to the original presentation profile. Alternatively, the web content could be rendered based on the current navigational choices, but with an emphasis on user's 46 original profile (e.g., 80% original—20% current). In another embodiment, the presentation profile could be updated regardless of whether the individual using the system is a guest. In this case, the presentation profile could be updated with a diminished emphasis on the current choices. For example, if the guest made a selection that would normally result in an updating weight of “visual—3,” then profile system 40 might only update the presentation profile with “visual—1.” In yet another embodiment, each deviation is stored in database 18. When a predetermined quantity of deviations are present, the presentation profile could be updated. Thus, regardless of whether the deviations result from a changing behavioral pattern of user 46, or from a guest, the profile could be updated.

As further indicated above, user 46 could have designated one or more guest users and corresponding presentation profiles. To this extent, presentation system 36 could detect whether a current user is user 46 or a registered guest by comparing the current navigational choices to historical choices stored in database 18. If the current choices fit a profile for a registered guest, it could be assumed that the current user is the guest. Alternatively, a registered guest could log on with a specific identity, in which case the corresponding presentation profile would be retrieved from database 18. In the event no presentation profile exists for the registered guest, an initial profile will be created in the same manner as it was for user 46.

The present invention could also provide a split screen feature so that more than one user could view the web content on a display simultaneously. For example, if user 46 and his/her spouse (e.g., a registered guest user) were viewing the monitor simultaneously, presentation system 36 (e.g., rendering system 44) could provide a control (e.g., a check box) for requesting a split screen. This would allow each split to display web content according to the determined learning style of a particular user. Thus, for example, the left side of the screen could display web content according to user's 46 presentation profile, while the right side could display the web content according to the spouse's presentation profile.

It should also be understood that the present invention could allow user 46 or any guests to modify the web content as displayed. For example, if user's 46 presentation profile resulted in a heavily graphical display of web content, and user 46 desired to view the web content in a more analytical style, controls could be provided for user 46 to change the presentation style. For example, user could change the analytical values in his/her presentation profile by manipulating up/down (or left/right) arrows adjacent an “analytical meter” in the display. This would result in the web content be re-displayed in user's 46 desired style. To this extent, the present invention could be implemented with override controls for user 46 (or his/her guest users) to manually alter the way in which the web content is displayed. It should be understood that the precise controls that are used to manually alter the presentation style are not intended to be limiting, and this feature can be implemented in any known manner.

It is understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls web server 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

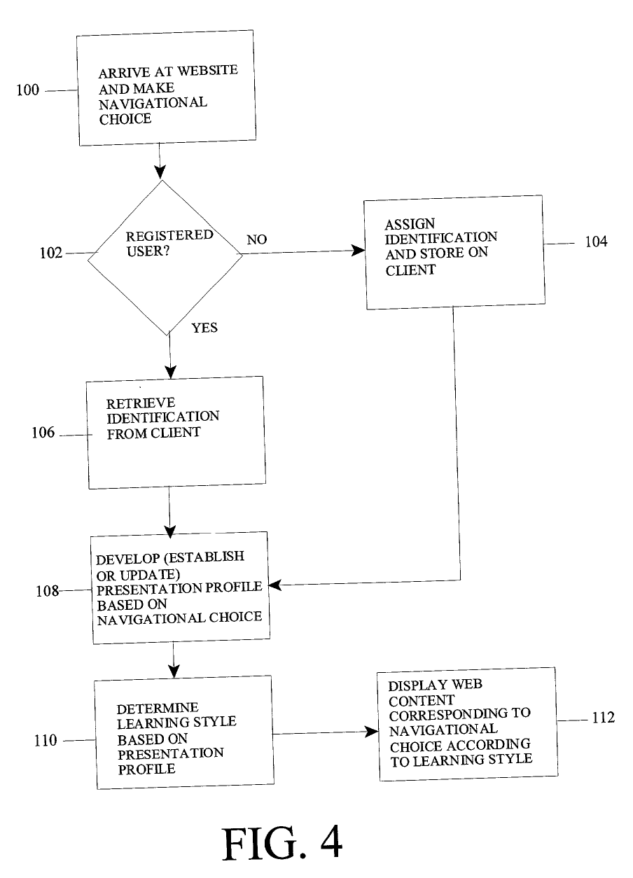

Referring now to FIG. 4, a process flow diagram according to the present invention is shown. As depicted, a user will arrive at a website and make a navigational choice 100. Once the choice is made, it will be determined whether the user is a registered user or an existing user 102. If the user is a new user, a user identification will be assigned and stored on the web client 104. If the user is a registered user, the previously assigned user identification will be retrieved from the web client 106. In either event, the presentation profile for the user must be developed (e.g., established or updated) based on the navigational choice and any other factors deemed necessary (e.g., the referring website, etc.) 108. Once the profile has been developed, the user's learning style will be determined 110. As indicated above, this includes manipulating the presentation values of the profile according to a definable algorithm. Then, the web content corresponding to the navigational choice will be presented to the user according to the determined learning style 112. In one embodiment, this includes formatting raw web content into the applicable learning style. In another embodiment, the web content is stored in the database already formatted into multiple learning styles, and the version that corresponds to the determined learning style is presented to the user.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, although presentation system 36 has been depicted as including four separate sub-systems for performing the functions described herein, it should be understood that the present invention could actually be implemented with any quantity of systems and/or sub-systems.

1. A method for presenting web content according to a determined learning style, comprising:
developing a presentation profile based on a website navigational choice;
determining a learning style based on the presentation profile; and
presenting web content according to the learning style.

2. The method of claim 1 further comprising assigning an identification, prior to the developing step.

3. The method of claim 1 further comprising storing the presentation profile in a database.

4. The method of claim 1, wherein the determining step comprises manipulating the presentation profile according to an algorithm.

5. The method of claim 1, wherein the developing step comprises assigning presentation values based on the website navigational choice.

6. The method of claim 1 further comprising formatting the web content based on the learning style, prior to the presenting step.

7. The method of claim 1 further comprising retrieving the web content in a format that corresponds to the learning style from a database, prior to the presenting step.

8. The method of claim 1, wherein the learning style is selected from the group consisting of visual, auditory, emotional and analytical.

9. The method of claim 1, wherein the web content corresponds to the navigational choice.

10. The method of claim 1, wherein the developing step comprises developing an initial presentation profile based on an initial website navigational choice.

11. The method of claim 10 further comprising:
making an additional website navigational choice; and
updating the presentation profile to reflect the additional website navigational choice.

12. The method of claim 11 further comprising identifying a deviation by comparing the additional website navigational choice to previous website navigational choices prior to the updating step.

13. The method of claim 12, wherein the presentation profile is not updated if a deviation is identified.

14. The method of claim 12 further comprising storing the deviation, wherein the presentation profile is updated when a predetermined quantity of deviations are stored.

15. A method for presenting web content according to a determined learning style, comprising:
a user making a website navigational choice;
developing a presentation profile for the user by assigning at least one presentation value based on the website navigational choice;
determining a learning style for the user by manipulating the at least one presentation value according to a definable algorithm; and
presenting web content corresponding to the website navigational choice according to the learning style.

16. The method of claim 15, further comprising:
assigning an identification to the user, prior to the developing step; and
storing the identification on a client operated by the user.

17. The method of claim 15, further comprising storing the presentation profile in a database.

18. The method of claim 15, further comprising formatting the web content according to the learning style.

19. The method of claim 15, further comprising retrieving the web content in a format that corresponds to the learning style from a database, prior to the presenting step.

20. The method of claim 15, wherein the learning style is selected from the group consisting of visual, auditory, emotional and analytical.

21. The method of claim 15 further comprising:
making an additional website navigational choice; and
updating the presentation profile to reflect the additional website navigational choice.

22. The method of claim 21 further comprising identifying a deviation by comparing the additional website navigational choice to previous website navigational choices prior to the updating step.

23. The method of claim 22, wherein the presentation profile is not updated if a deviation is identified.

24. The method of claim 22, further comprising storing the deviation, wherein the presentation profile is updated when a predetermined quantity of deviations are stored.

25. The method of claim 15, wherein the definable algorithm is changeable prior to the determining step.

26. A system for presenting web content according to a determined learning style, comprising:
a registration system for assigning an identification to a user;
a profile system for developing a presentation profile based on a website navigational choice made by the user;
a style system for determining a learning style based on the presentation profile; and
a rendering system for presenting web content according to the learning style.

27. The system of claim 26, wherein the registration system further stores the identification on a client operated by the user.

28. The system of claim 26, wherein the profile system assigns at least one presentation value based on the website navigational choice, and wherein the style system manipulates the at least one presentation value according to a predetermined algorithm.

29. The system of claim 28, wherein the definable algorithm is changeable via the style system

30. The system of claim 26, wherein the rendering system formats the web content according to the learning style.

31. The system of claim 26, wherein the rendering system retrieves the web content in a format that corresponds to the learning style from a database.

32. The system of claim 26, wherein the profile system further updates the presentation profile based on an additional website navigational choice.

33. The system of claim 32, wherein the profile system further determines whether the additional website navigational choice deviates from previous website navigational choices prior to updating the presentation profile, and wherein the presentation profile is not updated if the additional website navigational choice deviates from the previous website navigational choices.

34. The system of claim 26, wherein the profile system further identifies a deviation by comparing the additional website navigational choice to previous website navigational choices, wherein the deviation is stored in a database, and wherein the presentation profile is updated when a predetermined quantity of deviations are stored.

35. A program product stored on a recordable medium for presenting web content according to a determined learning style, which when executed, comprises:
program code for assigning an identification to a user;
program code for developing a presentation profile based on a website navigational choice made by the user;
program code for determining a learning style based on the presentation profile; and
program code for presenting web content according to the learning style.

36. The program product of claim 35, further comprising program code for storing the identification on a client operated by the user.

37. The program product of claim 35, wherein the program code for developing assigns at least one presentation value based on the website navigational choice, and wherein the program code for determining manipulates the at least one presentation value according to a predetermined algorithm.

38. The program product of claim 35, further comprising program code for formatting the web content according to the learning style.

39. The program product of claim 35, further comprising program code for retrieving the web content in a format that corresponds to the learning style from a database.

40. The program product of claim 35, wherein the program code for developing further updates the presentation profile based on an additional website navigational choice.

41. The program product of claim 40, wherein the program code for developing further determines whether the additional website navigational choice deviates from previous website navigational choices prior to updating the presentation profile, and wherein the presentation profile is not updated if the additional website navigational choice deviates from the previous website navigational choices.

42. The program product of claim 35, wherein the program code for developing further identifies a deviation by comparing an additional website navigational choice to previous website navigational choices, wherein the deviation is stored in a database, and wherein the presentation profile is updated when a predetermined quantity of deviations are stored.
